(19) United States
(12) Patent Application Publication
(10) Pub. No.: US 2025/0006480 A1
(43) Pub. Date: Jan. 2, 2025

(54) ION DETECTOR AND MASS SPECTROMETER

(71) Applicants: HAMAMATSU PHOTONICS K.K., Hamamatsu-shi (JP); SHIMADZU CORPORATION, Kyoto-shi (JP)

(72) Inventors: Junichi KONDO, Hamamatsu-shi (JP); Takeshi Endo, Hamamatsu-shi (JP); Shinjiro Fujita, Kyoto-shi (JP)

(73) Assignees: HAMAMATSU PHOTONICS K.K., Hamamatsu-shi (JP); SHIMADZU CORPORATION, Kyoto-shi (JP)

(21) Appl. No.: 18/751,600

(22) Filed: Jun. 24, 2024

(30) Foreign Application Priority Data
Jun. 29, 2023 (JP) 2023-107175

(51) Int. Cl. H01J 49/02; H01J 49/42

(52) U.S. Cl. CPC H01J 49/025; H01J 49/42

(57) ABSTRACT

An ion detector includes a conversion dynode having a conversion region, an electron multiplier including a first-stage dynode, a box electrode including a first opening through which the ions traveling to the conversion region pass and a second opening through which the electrons traveling to the first-stage dynode pass, a conductive shielding portion disposed in the first opening and including a gap through which the ions traveling to the conversion region pass, and a potential application unit which applies a first potential to the conversion dynode, applies a second potential to the first-stage dynode, applies a third potential to the box electrode, and applies a fourth potential to the shielding portion. The first potential and the third potential have polarities opposite to a polarity of the ions, the second potential is higher than the first potential, and the third potential and the fourth potential are substantially the same potential.

### TECHNICAL FIELD

The present disclosure relates to an ion detector and a mass spectrometer.

### BACKGROUND

As an ion detector for detecting positive ions, an ion detector including a conversion dynode that emits electrons by incident ions, an electron multiplier that multiplies electrons emitted from the conversion dynode, and a box electrode that houses the conversion dynode and has a first opening through which the ions traveling to the conversion dynode pass and a second opening through which the electrons traveling from the conversion dynode to a first-stage dynode pass has been known (see, for example, Japanese Unexamined Patent Publication No. 2011-086403). In such an ion detector, the box electrode may be used to suppress incidence of stray light that may be noise on the conversion dynode.

### SUMMARY

In the ion detector described above, it is conceivable that a potential applied to the conversion dynode can be switched in order to enable not only detection of the positive ions but also detection of the negative ions. Specifically, it is conceivable that the positive potential is applied to the conversion dynode, and the positive ions emitted from the conversion dynode by the incidence of the negative ions are incident on the first-stage dynode. In this case, since conversion efficiency from the negative ions to the positive ions is low, there is a concern that detection efficiency of the negative ions is reduced as a result.

An object of the present disclosure is to provide an ion detector and a mass spectrometer capable of improving ion detection efficiency for each of positive ions and negative ions.

An ion detector according to an aspect of the present disclosure includes a conversion dynode including a conversion region where electrons are emitted by incident ions, an electron multiplier including a first-stage dynode on which the electrons are incident, a box electrode housing the conversion dynode, and including a first opening through which the ions traveling to the conversion region pass and a second opening through which the electrons traveling to the first-stage dynode from the conversion region pass, a conductive shielding portion disposed in the first opening and including a gap through which the ions traveling to the conversion region pass, and a potential application unit which applies a first potential to the conversion dynode, applies a second potential to the first-stage dynode, applies a third potential to the box electrode, and applies a fourth potential to the shielding portion. The first potential and the third potential have polarities opposite to a polarity of the ions, the second potential is higher than the first potential, and the third potential and the fourth potential are substantially the same potential.

A mass spectrometer according to an aspect of the present disclosure includes an ionization unit, a mass separation unit, and an ion detector. The ion detector includes a conversion dynode including a conversion region where electrons are emitted by incident ions, an electron multiplier including a first-stage dynode on which the electrons are incident, a box electrode housing the conversion dynode, and including a first opening through which the ions traveling to the conversion region pass and a second opening through which the electrons traveling to the first-stage dynode from the conversion region pass, a conductive shielding portion disposed in the first opening and including a gap through which the ions traveling to the conversion region pass, and a potential application unit which applies a first potential to the conversion dynode, applies a second potential to the first-stage dynode, applies a third potential to the box electrode, and applies a fourth potential to the shielding portion, the first potential and the third potential have polarities opposite to a polarity of the ions, the second potential is higher than the first potential, and the third potential and the fourth potential are substantially the same potential.

### BRIEF DESCRIPTION OF THE DRAWINGS

FIG. 1 is a configuration diagram of an ion detector according to an embodiment;

FIGS. 2A and 2B are diagrams illustrating an example of an electric field distribution formed in the ion detector;

FIGS. 3A and 3B are diagrams illustrating an example of an electric field distribution formed in the ion detector;

FIGS. 4A and 4B are diagrams illustrating ion detection efficiency in the ion detector; and

FIG. 5 is a configuration diagram of a mass spectrometer according to the embodiment.

### DETAILED DESCRIPTION

Hereinafter, an embodiment of the present disclosure will be described in detail with reference to the drawings. Note that, the same or corresponding parts in the drawings are denoted with the same reference signs, and repetitive descriptions will be omitted.

### Ion Detector of Embodiment

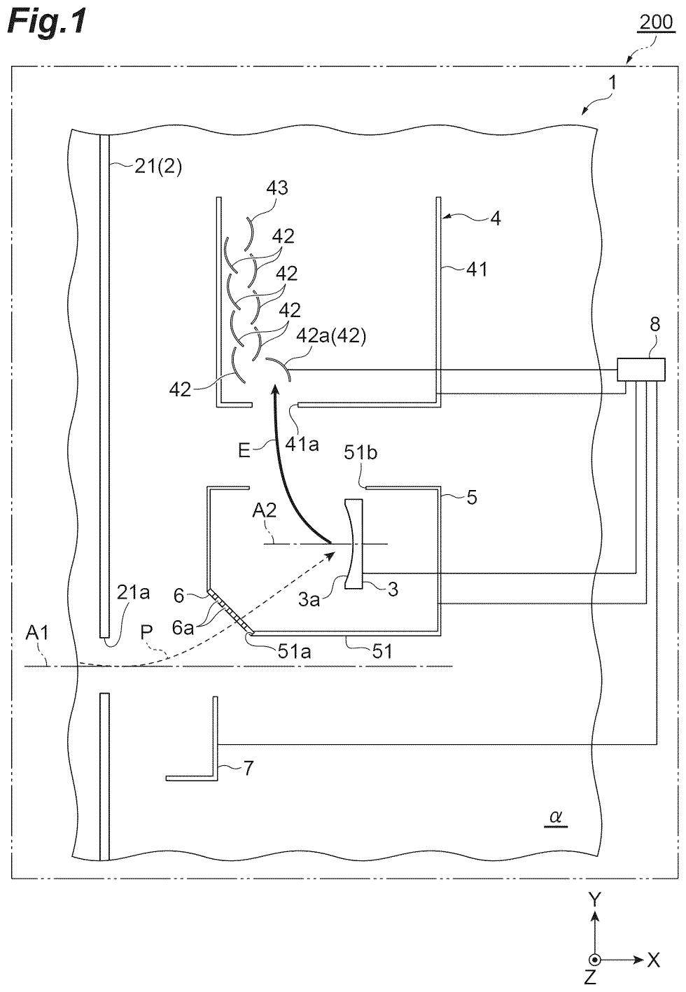

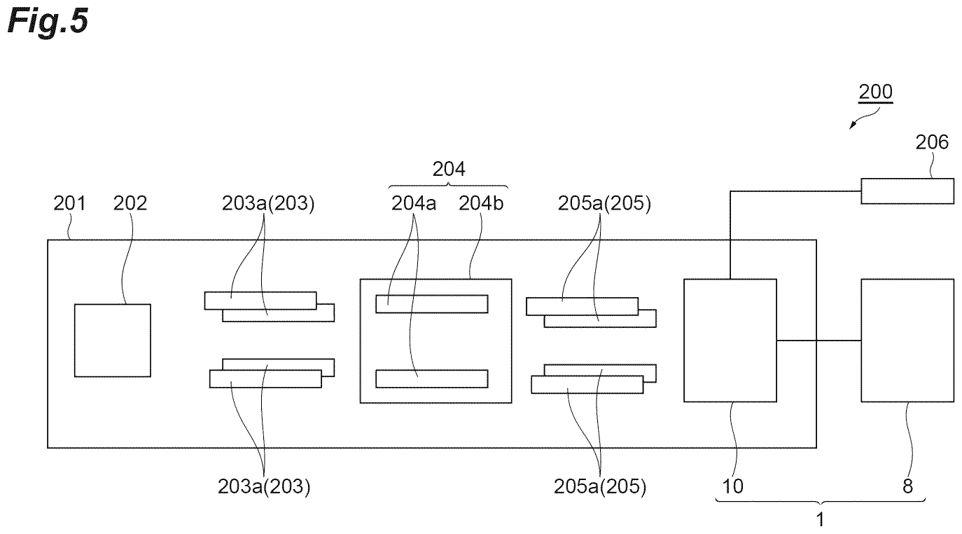

As illustrated in FIG. 1, an ion detector 1 includes a partition 2, a conversion dynode 3, an electron multiplier 4, a box electrode 5, a shielding portion 6, a deflection electrode 7, and a potential application unit 8. The ion detector 1 is housed in a housing 201 (see FIG. 5) of a mass spectrometer 200 and is disposed within a vacuum space. A material of the partition 2 is, for example, metal such as stainless steel. An aperture 21a is formed in a wall 21 of the partition 2. The aperture 21a has a center line (second center line) A1 parallel to an X-axis direction. A shape of the aperture 21a viewed from the X-axis direction is, for example, a circular shape. Hereinafter, one direction perpendicular to the X-axis direction is referred to as a Y-axis direction, and a direction perpendicular to both the X-axis direction and the Y-axis direction is referred to as a Z-axis direction.

In the present embodiment, the ion detector 1 is used as a part of the mass spectrometer 200. In the mass spectrometer 200, a sample is ionized by an electrospray ionization method. The mass spectrometer 200 selects ions P to be detected from generated ions by using a quadrupole. The ions P to be detected are introduced into the ion detector 1 via the aperture 21a. The ion detector 1 detects the incident ions P. In the present embodiment, the ions P may be positive ions or negative ions. In addition, a potential of the housing 201 (see FIG. 5) is described as a ground potential.

The conversion dynode 3 has a surface including a conversion region 3a. The positive ions or negative ions are incident, and thus, the conversion region 3a emits electrons E. The conversion region 3a is a region recessed on a side opposite to a space where the electrons E are emitted. A material of the conversion dynode 3 is, for example, metal such as stainless steel. The conversion dynode 3 is supported by a support member (not illustrated) within the box electrode 5. The conversion dynode 3 is disposed on one side in the Y-axis direction with respect to the center line A1. The conversion region 3a faces one side (aperture 21a side) in the X-axis direction on a plane a including the center line A1 and perpendicular to the Z-axis direction. The conversion region 3a has a center line (first center line) A2 parallel to the X-axis direction.

A first potential is applied to the conversion dynode 3 by the potential application unit 8. The first potential is a potential having a polarity opposite to a polarity of the ions P. As an example, in a case where the ions P is the positive ions, the first potential is −10 kV. In this case, the ions P are incident on the conversion region 3a with an energy of, for example, 10 keV, and thus, the electrons E are emitted from the conversion region 3a. As an example, in a case where the ions P are the negative ions, the first potential is +5.5 kV. In this case, the ions P are incident on the conversion region 3a with an energy of, for example, 5.5keV, and thus, the electrons E are emitted from the conversion region 3a. Normally, regardless of whether the ions P are the positive ions or negative ions, the amount of electrons E to be emitted increases as the energy of the ions P incident on the conversion region 3a increases. That is, the higher an absolute value of the first potential, the higher conversion efficiency from the ions P to the electron E can be.

The electron multiplier 4 is disposed on one side (side opposite to the center line A1) in the Y-axis direction with respect to the center line A2. In the present embodiment, the electron multiplier 4 includes a wall 41 made of metal, a plurality of dynodes 42, and an anode 43. The electron multiplier 4 is supported by a support member (not illustrated). An electron passage opening 41a through which the electrons E pass is formed in the wall 41. The electron passage opening 41a is open in the Y-axis direction. A shape of the electron passage opening 41a viewed from the Y-axis direction is, for example, a quadrangular shape. The plurality of dynodes 42 and the anode 43 are lined up on the plane a. Materials of each dynode 42 and the anode 43 are, for example, metal such as stainless steel. Among the plurality of dynodes 42, a first-stage dynode 42a faces the electron passage opening 41a in the Y-axis direction. In the electron multiplier 4, the electrons E having passed through the electron passage opening 41a are incident on a surface of the first-stage dynode 42a, and thus, secondary electrons (not illustrated) are emitted from the first-stage dynode 42a. The secondary electrons are multiplied by each dynode 42 at a subsequent stage and are incident on the anode 43. The anode 43 is connected to a signal processing circuit via a capacitor (not illustrated). The anode 43 is configured to output the secondary electrons as a pulse signal.

A second potential is applied to the first-stage dynode 42a by the potential application unit 8. The second potential is higher than the first potential of the conversion dynode 3. As an example, the second potential is +7 kV both in a case where the ions P are the positive ions and in a case where the ions P are the negative ions. A predetermined potential is applied to each dynode 42 other than the first-stage dynode 42a by the potential application unit 8 such that the secondary electrons emitted from the first-stage dynode 42a sequentially travel to each dynode 42 at a subsequent stage. As an example, a potential higher than +7 kV is applied to each dynode 42 other than the first-stage dynode 42a regardless of whether the ions P are the positive ions or negative ions. A predetermined potential is applied to the anode 43 by the potential application unit 8. As an example, the predetermined potential is +9 kV both in a case where the ions P are the positive ions and in a case where the ions P are the negative ions. In the ion detector 1, the second potential is applied to the wall 41 of the electron multiplier 4 by the potential application unit 8. That is, in the present embodiment, regardless of the polarity of the ions P, the electron multiplier 4 is floated to have a positive polarity.

The box electrode 5 houses the conversion dynode 3 to partition a space where the conversion dynode 3 is disposed and a space where the electron multiplier 4 is disposed. The box electrode 5 is disposed on one side (conversion dynode 3 side) in the Y-axis direction with respect to the center line A1, and is disposed between the center line Al and the electron multiplier 4 on the plane α. A shape of the box electrode 5 is, for example, a rectangular parallelepiped box shape. A material of the box electrode 5 is, for example, metal such as stainless steel. The box electrode 5 is supported by a support member (not illustrated). The box electrode 5 does not overlap the aperture 21a but overlaps the wall 21 as viewed from the X-axis direction. Accordingly, it is possible to suppress incidence of stray light, which is generated in the mass spectrometer 200 and may be noise, on the box electrode 5.

An ion passage opening (first opening) 51a through which the ions P traveling to the conversion region 3a pass is formed in a wall 51. The ion passage opening 51a is formed at a corner portion of the box electrode 5 on the aperture 21a side as viewed from the Z-axis direction on the plane α. The ion passage opening 51a is disposed on one side (center line A1 side) with respect to the center line A2 as viewed from the Z-axis direction (direction perpendicular to the center line A2). The ion passage opening 51a is inclined to be separated from the aperture 21a as becoming close to the center line A1 as viewed from the Z-axis direction (direction perpendicular to the center line A1). A shape of the ion passage opening 51a as viewed from a direction perpendicular to the ion passage opening 51a is, for example, a quadrangular shape.

An electron passage opening (second opening) 51b through which the electrons E traveling from the conversion region 3a to the first-stage dynode 42a of the electron multiplier 4 pass is formed in the wall 51. The electron passage opening 51b is disposed on the other side (electron multiplier 4 side) with respect to the center line A2 as viewed from the Z-axis direction (direction perpendicular to the center line A2). The electron passage opening 51b faces the electron passage opening 41a on the plane α. A shape of the electron passage opening 51b as viewed from the Y-axis direction is, for example, a circular shape.

A third potential is applied to the box electrode 5 by the potential application unit 8. The third potential is a potential having a polarity opposite to the polarity of the ions P. The third potential is substantially the same potential as the first potential. Here, substantially the same potential means that the third potential is 90% or more and 110% or less in a case where the first potential is 100%. In the present embodiment, the third potential is the same potential as the first potential. As an example, the third potential is −10 kV in a case where the ions P are the positive ions. Accordingly, the incident positive ions travel toward the ion passage opening 51a while being gradually separated from the center line A1 of the aperture 21a toward one side in the Y-axis direction. As an example, the third potential is +5.5 kV in a case where the ions P are the negative ions. Accordingly, the incident negative ions travel toward the ion passage opening 51a while being gradually separated from the center line A1 of the aperture 21a toward one side in the Y-axis direction.

The shielding portion 6 is disposed in the ion passage opening 51a, and is electrically connected to the box electrode 5, for example, by coming into contact with the box electrode 5. Similarly to the ion passage opening 51a, the shielding portion 6 is inclined to be separated from the aperture 21a as becoming close to the center line A1 as viewed from the Z-axis direction (direction perpendicular to the center line A1). A material of the shielding portion 6 is a conductive material, and is, for example, metal such as stainless steel. The shielding portion 6 has a plurality of gaps 6a through which the ions P traveling to the conversion region 3a pass. The plurality of gaps 6a are two-dimensionally disposed along the ion passage opening 51a. In the present embodiment, the shielding portion 6 is a grid-shaped member, and the plurality of gaps 6a are disposed in a matrix. A total area of the plurality of gaps 6a is, for example, 50% or more and 97% or less of an area of the ion passage opening 51a.

A fourth potential is applied to the shielding portion 6 by the potential application unit 8 via the box electrode 5. The fourth potential is a potential having a polarity opposite to the polarity of the ions P. The fourth potential is substantially the same potential as the third potential. Here, substantially the same potential means that the fourth potential is 90% or more and 110% or less in a case where the third potential is 100%. In the present embodiment, the fourth potential is the same potential as the third potential. As an example, the fourth potential is −10 kV in a case where the ions P are the positive ions. As an example, the fourth potential is +5.5 kV in a case where the ions P are the negative ions.

The deflection electrode 7 is disposed on the other side (side opposite to the box electrode 5) with respect to the center line A1 as viewed from the Z-axis direction (direction perpendicular to the center line A1). A material of the deflection electrode 7 is, for example, metal such as stainless steel. The deflection electrode 7 is supported by a support member (not illustrated) to be positioned on the plane α. As viewed from the Z-axis direction, a part of the deflection electrode 7 extends along the Y-axis direction. As viewed from the Z-axis direction, the other part of the deflection electrode 7 extends from the part toward the wall 21 along the X-axis direction. As viewed from the X-axis direction, the deflection electrode 7 does not overlap the aperture 21a but overlaps the wall 21. As viewed from the Y-axis direction, at least a part of the deflection electrode 7 overlaps the ion passage opening 51a.

A ground potential or a potential having the same polarity as the polarity of the ions P is applied to the deflection electrode 7 by the potential application unit 8. As an example, the potential is +500 V in a case where the ions P are the positive ions. As an example, the potential is −500 V in a case where the ions P are the negative ions.

The potential application unit 8 applies a predetermined potential to each of the conversion dynode 3, the electron multiplier 4, the box electrode 5, and the deflection electrode 7. The potential application unit 8 applies a predetermined potential to the shielding portion 6 via the box electrode 5. The potential application unit 8 is electrically connected to each of the conversion dynode 3, the electron multiplier 4, the box electrode 5, and the deflection electrode 7 by a wiring or the like. As described above, in a case where the ions P are the positive ions, the potential application unit 8 applies the first potential (for example, −10 kV) to the conversion dynode 3, applies the second potential (for example, +7 kV) higher than the first potential to the first-stage dynode 42a of the electron multiplier 4, applies the third potential (for example, −10 kV) that is the same potential as the first potential to the box electrode 5, applies the fourth potential (for example, −10 kV) that is the same potential as the third potential to the shielding portion 6, and applies, for example, +500 V to the deflection electrode 7. In a case where the ions P are the negative ions, the potential application unit 8 applies the first potential (for example, +5.5 kV) to the conversion dynode 3, applies the second potential (for example, +7 kV) higher than the first potential to the first-stage dynode 42a of the electron multiplier 4, applies the third potential (for example, +5.5 kV) that is the same potential as the first potential to the box electrode 5, applies the fourth potential (for example, +5.5 kV) that is the same potential as the third potential to the shielding portion 6, and applies, for example, −500 V to the deflection electrode 7. That is, the potential application unit 8 can switch the polarities of the first potential and the third potential and can change a value of each potential in accordance with the polarity of the ions P to be detected. As an example, the potential application unit 8 includes a plurality of power supplies or a combination of a power supply and resistance division.

In the present embodiment, the first-stage dynode 42a faces the electron passage opening 51b with the electron passage opening 41a interposed therebetween. As viewed from the Y-axis direction, an outer edge of the electron passage opening 41a is positioned inside an outer edge of the electron passage opening 51b. As viewed from the Y-axis direction, at least the conversion region 3a of the conversion dynode 3 is positioned inside the outer edge of the electron passage opening 51b.

In the ion detector 1 having the above-described configuration, in a case where the positive ions are detected, a predetermined potential is applied to each of the conversion dynode 3, the electron multiplier 4, the box electrode 5, the shielding portion 6, and the deflection electrode 7 by the potential application unit 8. Accordingly, an electric field that causes the positive ions to be incident on the conversion region 3a and an electric field that causes the electrons E to be incident on the first-stage dynode 42a are formed. In this state, the positive ions are incident from the aperture 21a, and the positive ions pass through the ion passage opening 51a of the box electrode 5. Then, the positive ions are incident on the conversion region 3a of the conversion dynode 3. The positive ions are incident, and thus, the electrons E are emitted from the conversion region 3a. Since the electric field that causes the electrons E to be incident on the first-stage dynode 42a is formed, the electrons E emitted from the conversion region 3a pass through the electron passage opening 51b of the box electrode 5 and the electron passage opening 41a of the electron multiplier 4, and are incident on the first-stage dynode 42a. When the electrons E are incident on the first-stage dynode 42a, the secondary electrons (not illustrated) are emitted from the first-stage dynode 42a. The secondary electrons are multiplied by each dynode 42 at a subsequent stage and are incident on the anode 43. Then, the anode 43 outputs the secondary electrons as the pulse signal, and thus, the ion detector 1 detects the positive ions.

In the ion detector 1, in a case where the negative ions are detected, a predetermined potential is applied to each of the conversion dynode 3, the electron multiplier 4, the box electrode 5, the shielding portion 6, and the deflection electrode 7 by the potential application unit 8. Accordingly, an electric field that causes the negative ions to be incident on the conversion region 3a and an electric field that causes the electrons E to be incident on the first-stage dynode 42a are formed. In this state, the negative ions are incident from the aperture 21a, and the negative ions pass through the ion passage opening 51a of the box electrode 5. Then, the negative ions are incident on the conversion region 3a of the conversion dynode 3. The negative ions are incident, and thus, the electrons E are emitted from the conversion region 3a. Since the electric field that causes the electrons E to be incident on the first-stage dynode 42a is formed, the electrons E emitted from the conversion region 3a pass through the electron passage opening 51b of the box electrode 5 and the electron passage opening 41a of the electron multiplier 4, and are incident on the first-stage dynode 42a. When the electrons E are incident on the first-stage dynode 42a, the secondary electrons (not illustrated) are emitted from the first-stage dynode 42a. The secondary electrons are multiplied by each dynode 42 at a subsequent stage and are incident on the anode 43. Then, the anode 43 outputs the secondary electrons as the pulse signal, and thus, the ion detector 1 detects the negative ions. That is, in the ion detector 1, since the electron multiplier 4 is floating in the positive polarity, even in a case where the negative ions are detected, the electrons E emitted from the conversion region 3a can be incident on the first-stage dynode 42a.

As described above, in the ion detector 1, in a case where the positive ions are detected, the first potential which is a negative potential is applied to the conversion dynode 3, and the second potential higher than the first potential is applied to the first-stage dynode 42a of the electron multiplier 4. At this time, the third potential which is a negative potential is applied to the box electrode 5 housing the conversion dynode 3, and the fourth potential which is substantially the same potential as the third potential is applied to the shielding portion 6 disposed in the ion passage opening 51a of the box electrode 5. Accordingly, the positive ions can be incident on the conversion region 3a of the conversion dynode 3 via the plurality of gaps 6a of the shielding portion 6 disposed in the ion passage opening 51a of the box electrode 5. In addition, the electrons E emitted from the conversion region 3a can be incident on the first-stage dynode 42a via the electron passage opening 51b of the box electrode 5. At this time, since the box electrode 5 suppresses an interference between the electric field that causes the positive ions to be incident on the conversion region 3a and the electric field that causes the electrons E to be incident on the first-stage dynode 42a, the positive ions can be reliably incident on the conversion region 3a, and the electrons E can be reliably incident on the first-stage dynode 42a. Further, since the shielding portion 6 suppresses forming of an electric field that attracts the electrons E in the box electrode 5 via the ion passage opening 51a, the electrons E can be reliably incident on the first-stage dynode 42a. Thus, in accordance with the ion detector 1, detection efficiency of the positive ions can be improved.

In the ion detector 1, in a case where the negative ions are detected,

the first potential that is a positive potential is applied to the conversion dynode 3, and the second potential higher than the first potential is applied to the first-stage dynode 42a of the electron multiplier 4. At this time, the third potential which is a positive potential is applied to the box electrode 5 housing the conversion dynode 3, and the fourth potential which is substantially the same potential as the third potential is applied to the shielding portion 6 disposed in the ion passage opening 51a of the box electrode 5. Accordingly, the negative ions can be incident on the conversion region 3a of the conversion dynode 3 via the plurality of gaps 6a of the shielding portion 6 disposed in the ion passage opening 51a of the box electrode 5. In addition, the electrons E emitted from the conversion region 3a can be incident on the first-stage dynode 42a via the electron passage opening 51b of the box electrode 5. At this time, since the box electrode 5 suppresses an interference between the electric field that causes the negative ions to be incident on the conversion region 3a and the electric field that causes the electrons E to be incident on the first-stage dynode 42a, the negative ions can be reliably incident on the conversion region 3a, and the electrons E can be reliably incident on the first-stage dynode 42a. Further, since the shielding portion 6 suppresses forming of an electric field that pushes back the electrons E in the box electrode 5 via the ion passage opening 51a, the electrons E can be reliably incident on the first-stage dynode 42a. Thus, in accordance with the ion detector 1, the detection efficiency of negative ions can be improved.

As described above, in accordance with the ion detector 1, it is possible to improve the ion detection efficiency for each of the positive ions and the negative ions.

In the ion detector 1, the shielding portion 6 has the plurality of gaps 6a two-dimensionally disposed along the ion passage opening 51a. Accordingly, in a case where the positive ions are detected, it is possible to cause the positive ions to reliably pass through the ion passage opening 51a while reliably suppressing the forming of the electric field that attracts the electrons E emitted from the conversion region 3a in the box electrode 5 via the ion passage opening 51a. In a case where the negative ions are detected, it is possible to cause the negative ions to reliably pass through the ion passage opening 51a while reliably suppressing the forming of the electric field that pushes back the electrons E emitted from the conversion region 3a in the box electrode 5 via the ion passage opening 51a. Accordingly, it is possible to further improve the ion detection efficiency for each of the positive ions and the negative ions.

In the ion detector 1, the ion passage opening 51a is disposed on one side with respect to the center line A2 as viewed from the direction perpendicular to the center line A2 passing through a center of the conversion region 3a, the electron passage opening 51b is disposed on the other side with respect to the center line A2 as viewed from the direction perpendicular to the center line A2, and the first-stage dynode 42a faces the electron passage opening 51b. Accordingly, since the first-stage dynode 42a faces the electron passage opening 51b of the box electrode 5, the electric field that causes the electrons E to be incident on the first-stage dynode 42a can be easily and reliably formed, and the electrons E can be more reliably incident on the first-stage dynode 42a. In addition, since the ion passage opening 51a of the box electrode 5 is disposed on one side with respect to the center line A2 of the conversion region 3a, and the electron passage opening 51b of the box electrode 5 is disposed on the other side with respect to the center line A2 of the conversion region 3a, it is possible to suppress the influence of the electric field that causes the electrons E to be incident on the first-stage dynode 42a on the ions P to be detected, which travel to the conversion region 3a, and it is possible to more reliably cause the ions P to be detected to be incident on the conversion region.

In the ion detector 1, the first potential and the third potential are substantially the same potential. Accordingly, it is possible to facilitate switching of the polarities of the first potential and the third potential corresponding to the polarity of the ions P to be detected while simplifying the structure of the potential application unit 8.

In the ion detector 1, the total area of the plurality of gaps 6a is 50% or more of the area of the ion passage opening 51a. Accordingly, the ions P to be detected can be more reliably incident on the conversion region 3a of the conversion dynode 3 via the plurality of gaps 6a of the shielding portion 6 disposed in the ion passage opening 51a of the box electrode 5. Accordingly, it is possible to further improve the ion detection efficiency for each of the positive ions and the negative ions.

The ion detector 1 includes the partition 2 having the aperture 21athat causes the ions P traveling to the ion passage opening 51a to pass therethrough. Accordingly, it is possible to suppress the incidence of the electrons or ions that may be noise on the conversion region 3a. Accordingly, ion detection accuracy can be improved for each of the positive ions and the negative ions.

The ion detector 1 includes the deflection electrode 7, the box electrode 5 is disposed on one side with respect to the center line A1 as viewed from the direction perpendicular to the center line A1 of the aperture 21a, the deflection electrode 7 is disposed on the other side with respect to the center line A1 as viewed from the direction perpendicular to the center line A1, and the potential application unit 8 applies the ground potential or the potential having the same polarity as the polarity of the ions P to the deflection electrode 7. Accordingly, since the electric field that causes the ions P to be detected to travel to the ion passage opening 51a of the box electrode 5 can be reliably formed, the ions P to be detected can be more reliably incident on the conversion region 3a. Accordingly, it is possible to further improve the ion detection efficiency for each of the positive ions and the negative ions.

In the ion detector 1, the ion passage opening 51a is inclined to be separated from the aperture 21a as becoming close to the center line A1 as viewed from the direction perpendicular to the center line A1. Accordingly, since the ions P to be detected that have passed through the aperture 21a can be reliably incident on the ion passage opening 51a of the box electrode 5, the ions P to be detected can be more reliably incident on the conversion region 3a. Accordingly, it is possible to further improve the ion detection efficiency for each of the positive ions and the negative ions.

In the ion detector 1, the total area of the plurality of gaps 6a is 97% or less of the area of the ion passage opening 51a. Accordingly, in a case where the positive ions are detected, it is possible to more reliably suppress the forming of the electric field that attracts the electrons E emitted from the conversion region 3a in the box electrode 5 via the ion passage opening 51a. In a case where the negative ions are detected, it is possible to more reliably suppress the forming of the electric field that pushes back the electrons E emitted from the conversion region 3a in the box electrode 5 via the ion passage opening 51a. Accordingly, it is possible to further improve the ion detection efficiency for each of the positive ions and the negative ions.

### [Example of Electric Field Distribution]

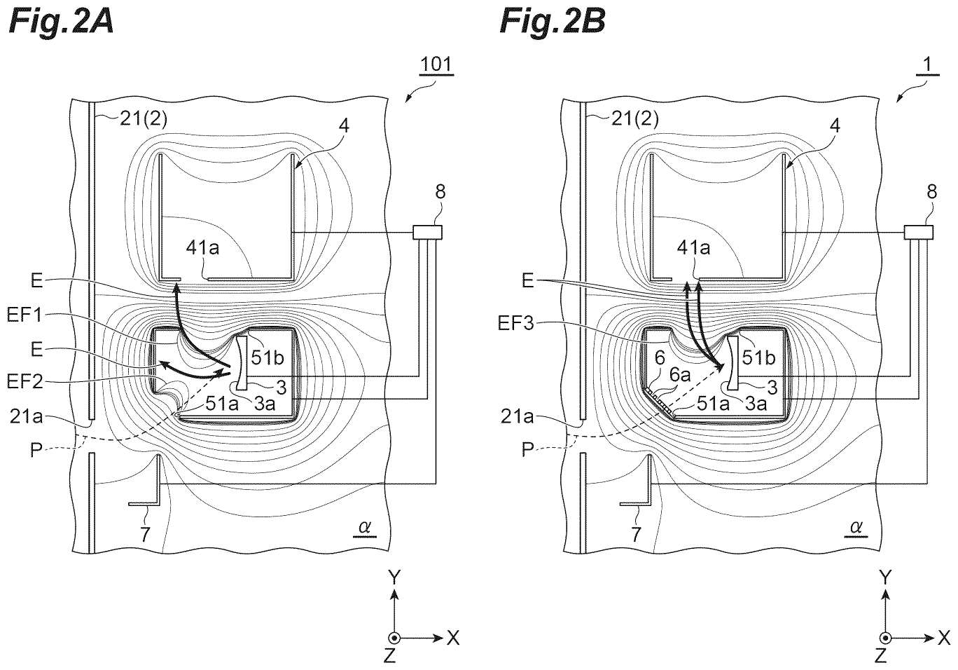

Advantages of the above-described shielding portion 6 in a case where the ions P are the positive ions will be described with reference to FIGS. 2A and 2B. In FIG. 2A, an electric field distribution formed in an ion detector 101 different from the ion detector 1 in a case where the ions P are the positive ions is indicated by an equipotential line. The ion detector 101 is different from the ion detector 1 in not including the shielding portion 6. In FIG. 2B, an electric field distribution formed in the ion detector 1 in a case where the ions P are the positive ions is indicated by an equipotential line. As described above, the first potential of the conversion dynode 3 is −10 kV, the second potential of the first-stage dynode 42a of the electron multiplier 4 is +7 kV, the third potential of the box electrode 5 is −10 kV, the fourth potential of the shielding portion 6 is −10 kV, and the potential of the deflection electrode 7 is +500 V.

As illustrated in FIG. 2A, in the ion detector 101, an electric field EF1 that causes the electrons E to be incident on the first-stage dynode 42a is formed. The electric field EF1 spreads from the electron passage opening 51b into the box electrode 5. In addition, in the ion detector 101, an electric field EF2 that attracts the electrons E is formed. The electric field EF2 spreads from the ion passage opening 51a into the box electrode 5. Accordingly, since the electrons E are influenced not only by the electric field EF1 but also by the electric field EF2, the electrons E are attracted toward the ion passage opening 51a. As a result, in the ion detector 101, the electrons E are less likely to be incident on the first-stage dynode 42a.

As illustrated in FIG. 2B, in the ion detector 1, an electric field EF3 that causes the electrons E to be incident on the first-stage dynode 42a is formed. The electric field EF3 spreads from the electron passage opening 51b into the box electrode 5. In the ion detector 1, since the shielding portion 6 is disposed in the ion passage opening 51a, the forming of the electric field that attracts the electrons E in the box electrode 5 is suppressed unlike the ion detector 101. Accordingly, as compared with the case of the ion detector 101, the electrons E emitted from the conversion region 3a can be more reliably incident on the first-stage dynode 42a.

For the ion detector 101 illustrated in FIG. 2A and the ion detector 1 illustrated in FIG. 2B, the incidence efficiency of the electrons E emitted from the conversion region 3a to the first-stage dynode 42a was simulated. A value obtained by dividing a mass of the ions P by charges of the ions P (hereinafter also referred to as “m/z”) was 50. The ion detector 101 had an incidence efficiency of 76.1%, whereas the ion detector 1 had an incidence efficiency of 99.8%. As a result of this simulation, it has been found that, in a case where the ions P are the positive ions, the shielding portion 6 is disposed in the ion passage opening 51a, and thus, the amount of electrons E incident on the first-stage dynode 42a increases.

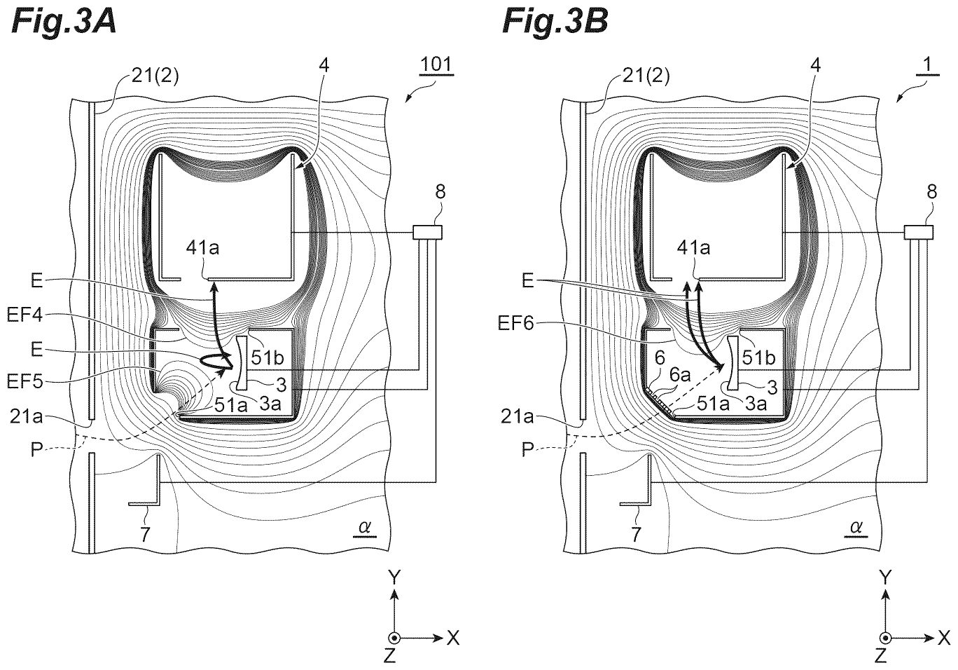

Advantages of the above-described shielding portion 6 in a case where the ions P are the negatives ion will be described with reference to FIGS. 3A and 3B. In FIG. 3A, the electric field distribution formed in the ion detector 101 in a case where the ions P are the negative ions is indicated by an equipotential line. In FIG. 3B, the electric field distribution formed in the ion detector 1 in a case where the ions P are the negative ions is indicated by an equipotential line. As described above, the first potential of the conversion dynode 3 is +5.5 kV, the second potential of the first-stage dynode 42a of the electron multiplier 4 is +7 kV, the third potential of the box electrode 5 is +5.5 kV, the fourth potential of the shielding portion 6 is +5.5 kV, and the potential of the deflection electrode 7 is −500 V.

As illustrated in FIG. 3A, in the ion detector 101, an electric field EF4 that causes the electrons E to be incident on the first-stage dynode 42a is formed. The electric field EF4 spreads from the electron passage opening 51b into the box electrode 5. In addition, in the ion detector 101, an electric field EF5 that pushes back the electrons E is formed. The electric field EF5 spreads from the ion passage opening 51a into the box electrode 5. Accordingly, since the electrons E are influenced not only by the electric field EF4 but also by the electric field EF5, the electrons E are pushed back to a side opposite to the ion passage opening 51a. As a result, in the ion detector 101, the electrons E are less likely to be incident on the first-stage dynode 42a.

As illustrated in FIG. 3B, in the ion detector 1, an electric field EF6 that causes the electrons E to be incident on the first-stage dynode 42a is formed. The electric field EF6 spreads from the electron passage opening 51b into the box electrode 5. In the ion detector 1, since the shielding portion 6 is disposed in the ion passage opening 51a, the forming of the electric field that pushes back the electrons E in the box electrode 5 is suppressed unlike the ion detector 101. Accordingly, as compared with the case of the ion detector 101, the electrons E emitted from the conversion region 3a can be more reliably incident on the first-stage dynode 42a.

For the ion detector 101 illustrated in FIG. 3A and the ion detector 1 illustrated in FIG. 3B, the incidence efficiency of the electrons E emitted from the conversion region 3a to the first-stage dynode 42a was simulated. A value of m/z for the ions P was 50. The ion detector 101 had an incidence efficiency of 69.1%, whereas the ion detector 1 had an incidence efficiency of 91.2%. As a result of this simulation, it has been found that, in a case where the ions P are the negative ions, the shielding portion 6 is disposed in the ion passage opening 51a, and thus, the amount of electrons E incident on the first-stage dynode 42a increases.

### [Detection Example of Ions]

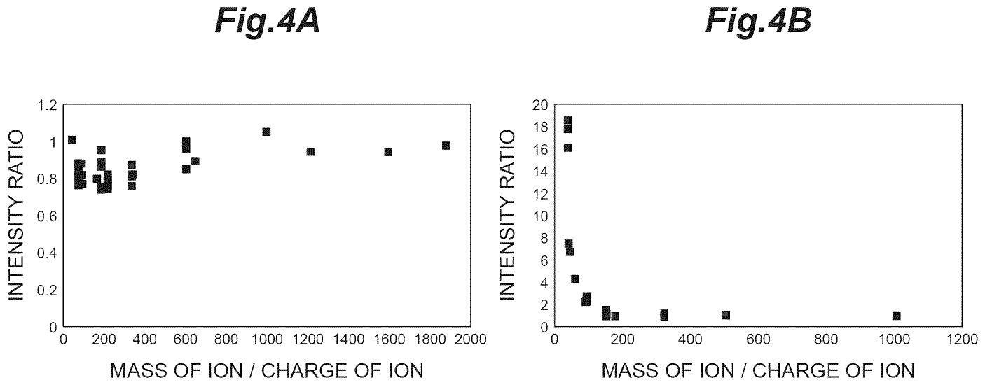

Ion intensity of the ions detected by the ion detector 1 will be described with reference to FIGS. 4A and 4B. FIG. 4A illustrates a result in a case where the positive ions are detected by the ion detector 1, and FIG. 4B illustrates a result in a case where the negative ions are detected by the ion detector 1. Each vertical axis in FIGS. 4A and 4B represents a value (intensity ratio) obtained by dividing the ion intensity detected by the ion detector 1 by ion intensity detected by an example of an ion detector of the related art (hereinafter, referred to as an “example of the related art”), and each horizontal axis in FIGS. 4A and 4B represents a value (m/z) obtained by dividing the mass of the ion to be detected by the charge of the ion. The example of the related art does not include the box electrode 5, the shielding portion 6, and the deflection electrode 7, and the potential applied to each member in the example of the related art is different from the potential of the ion detector 1.

The potential of each member of the ion detector 1 in FIG. 4A will be described. In the ion detector 1, the first potential of the conversion dynode 3 is −10 kV, the second potential of the first-stage dynode 42a of the electron multiplier 4 is +7 kV, the potential of the anode 43 is +9 kV, the third potential of the box electrode 5 is −10 kV, the fourth potential of the shielding portion 6 is −10 kV, and the potential of the deflection electrode 7 is +500 V. The potential of each member of the example of the related art in FIG. 4A will be described. In the example of the related art, the potential of the conversion dynode is −10 kV, the potential of the first-stage dynode of the electron multiplier is −2 kV, and the potential of the anode is the ground potential. As illustrated in FIG. 4A, in a case where the positive ions are detected, the detection efficiency of the ion detector 1 was about the same as the detection efficiency of the example of the related art.

The potential of each member of the ion detector 1 in FIG. 4B will be described. In the ion detector 1, the first potential of the conversion dynode 3 is +5.5 kV, the second potential of the first-stage dynode 42a of the electron multiplier 4 is +7 kV, the potential of the anode 43 is +9 k V, the third potential of the box electrode 5 is +5.5 kV, the fourth potential of the shielding portion 6 is +5.5 kV, and the potential of the deflection electrode 7 is −500 V. The potential of each member of the example of the related art in FIG. 4B will be described. In the example of the related art, the potential of the conversion dynode is +10 kV, the potential of the first-stage dynode of the electron multiplier is −2 kV, and the potential of the anode is the ground potential. As illustrated in FIG. 4B, in a case where the negative ions are detected, the detection efficiency of the ion detector 1 was superior to the detection efficiency of the example of the related art in a region where a value on the horizontal axis was 200 or less.

### [Mass Spectrometer of Embodiment]

A specific configuration of the above-described mass spectrometer 200 will be described with reference to FIG. 5. The mass spectrometer 200 includes the ion detector 1, the housing 201, an ionization unit 202, a first mass separation unit (mass separation unit) 203, a collision unit 204, a second mass separation unit (mass separation unit) 205, and a pulse count detector 206. In the mass spectrometer 200, the first mass separation unit 203, the collision unit 204, and the second mass separation unit 205 are disposed in series in this order. The ion detector 1 includes a detection unit 10 including the partition 2, the conversion dynode 3, the electron multiplier 4, the box electrode 5, the shielding portion 6, and the deflection electrode 7, and the potential application unit 8. The housing 201 houses the detection unit 10, the ionization unit 202, the first mass separation unit 203, the collision unit 204, and the second mass separation unit 205. The potential application unit 8 and the pulse count detector 206 are disposed outside the housing 201.

The ionization unit 202 generates ions from a sample introduced into the ionization unit 202. As an example, a liquid sample is introduced from a liquid chromatograph into the ionization unit 202. In the ionization unit 202, the sample is ionized by, for example, an electrospray ionization method.

The first mass separation unit 203 selectively transmits ions in which m/z is a predetermined value from the ions generated by the ionization unit 202. In the present embodiment, the first mass separation unit 203 is a quadrupole mass separation unit including four electrodes 203a. Each electrode 203a is a rod-shaped electrode and is disposed around a predetermined central axis. A predetermined potential is applied to each electrode 203a by a potential application unit (not illustrated), and an electric field of which a phase changes at a high speed is formed. Since the ions whose m/z is a predetermined value stably vibrate when the ions pass through the electric field, the ions can pass through the first mass separation unit 203.

The collision unit 204 generates product ions by dissociating ions (precursor ions) having passed through the first mass separation unit 203. The collision unit 204 includes a plurality of electrodes 204a and a collision chamber 204b. The number of the plurality of electrodes 204a is, for example, eight. Each electrode 204a is disposed around a predetermined central axis in the collision chamber 204b. A collision gas for collision with the precursor ions is introduced into the collision chamber 204b. As an example, the collision gas is argon gas. The precursor ions incident on the collision chamber 204b collide with the collision gas, and thus, the precursor ions are dissociated to generate the product ions. A predetermined potential is applied to each electrode 204a by a potential application unit (not illustrated), and a high-frequency electric field is formed. Since the product ions are accelerated by the electric field, the product ions smoothly travel toward an outside of the collision chamber 204b.

The second mass separation unit 205 selectively transmits ions in which m/z is a predetermined value from the ions (product ions) generated by the collision unit 204. In the present embodiment, the second mass separation unit 205 is a quadrupole mass separation unit including four electrodes 205a. Each electrode 205a is a rod-shaped electrode and is disposed around a predetermined central axis. A predetermined potential is applied to each electrode 205a by a potential application unit (not illustrated), and an electric field of which a phase changes at a high speed is formed. Since the ions of which m/z is a predetermined value stably vibrate when the ions pass through the electric field, the ions can pass through the second mass separation unit 205.

The ions having passed through the second mass separation unit 205 are incident, as the ions P to be detected, on the ion detector 1. The pulse count detector 206 counts the pulse signal output from the anode 43 described above. The mass spectrometer 200 is a quadrupole mass spectrometer including the first mass separation unit 203 and the second mass separation unit 205 that are quadrupole mass separation units. In the mass spectrometer 200, a signal-to-noise ratio (S/N) can be improved by two-stage mass separation by the first mass separation unit 203 and the second mass separation unit 205. Accordingly, the mass spectrometer 200 is suitable for detecting minor components contained in the sample.

In accordance with the configuration of the mass spectrometer 200 described above, in the ion detector 1, an appropriate potential is applied to the conversion dynode 3, the first-stage dynode 42a of the electron multiplier 4, the box electrode 5, and the shielding portion 6, and thus, a trajectory of the electrons E emitted from the conversion dynode 3 is optimized. Accordingly, even in a case where spread of an energy distribution and a spatial distribution of the ions transmitted through the first mass separation unit 203 or the second mass separation unit 205 is large, it is possible to improve the ion detection efficiency for each of the positive ions and the negative ions.

In the mass spectrometer 200, the first mass separation unit 203 is a quadrupole mass separation unit, and the second mass separation unit 205 is a quadrupole mass separation unit. Accordingly, the first mass separation unit 203 and the second mass separation unit 205 can be specifically configured.

### [Modification]

The present disclosure is not limited to the above embodiments. In the ion detector 1, one potential application unit 8 applies a predetermined potential to each of the conversion dynode 3, the electron multiplier 4, the box electrode 5, the shielding portion 6, and the deflection electrode 7, but each of a plurality of potential application units 8 may apply a predetermined potential to at least one of the conversion dynode 3, the electron multiplier 4, the box electrode 5, the shielding portion 6, and the deflection electrode 7.

In the ion detector 1, the shielding portion 6 is electrically connected to the box electrode 5, but the shielding portion 6 may not be electrically connected to the box electrode 5. As an example, the shielding portion 6 may be supported by a support member (not illustrated). In this case, the fourth potential may be applied to the shielding portion 6 by electrically connecting the potential application unit 8 to the shielding portion 6 by a wiring or the like.

In the ion detector 1, the shielding portion 6 is a grid-shaped member, but may be a honeycomb-shaped member. The plurality of gaps 6a of the shielding portion 6 are disposed in a matrix, but may be two-dimensionally disposed in another form. Further, the plurality of gaps 6a may be one-dimensionally disposed. In this case, each gap 6a may be formed in a slit shape. The shielding portion 6 may have at least one gap 6a.

In the ion detector 1, the electron passage opening 51b is disposed on the other side with respect to the center line A2 as viewed from the Z-axis direction and the first-stage dynode 42a faces the electron passage opening 51b, but the conversion region 3a, the electron passage opening 41a, the first-stage dynode 42a, and the electron passage opening 51b may be lined up on the plane α.

In the ion detector 1, the third potential is substantially the same potential as the first potential, but the third potential may not be substantially the same potential as the first potential. As an example, in a case where the ions P are the positive ions, the first potential may be −10 kV, and the third potential may be −11.5 kV. As an example, in a case where the ions P are the negative ions, the first potential may be +5.5 kV, and the third potential may be +6.1 kV.

In the ion detector 1, the total area of the plurality of gaps 6a is 50% or more of the area of the ion passage opening 51a, but the area of the gap 6a may be less than 50% of the area of the ion passage opening 51a.

The ion detector 1 may be used as a part of a mass spectrometer using time of flight (TOF), or may be used as a part of a mass spectrometer using plasma as an ion source.

The mass spectrometer 200 includes the first mass separation unit 203 and the second mass separation unit 205, but the mass spectrometer 200 may include at least one of the first mass separation unit 203 and the second mass separation unit 205. The mass spectrometer 200 may not include the collision unit 204.

An ion detector according to an aspect of the present disclosure is [1] “an ion detector including a conversion dynode including a conversion region where electrons are emitted by incident ions, an electron multiplier including a first-stage dynode on which the electrons are incident, a box electrode housing the conversion dynode, and including a first opening through which the ions traveling to the conversion region pass and a second opening through which the electrons traveling to the first-stage dynode from the conversion region pass, a conductive shielding portion disposed in the first opening and including a gap through which the ions traveling to the conversion region pass, and a potential application unit which applies a first potential to the conversion dynode, applies a second potential to the first-stage dynode, applies a third potential to the box electrode, and applies a fourth potential to the shielding portion. The first potential and the third potential have polarities opposite to a polarity of the ions, the second potential is higher than the first potential, and the third potential and the fourth potential are substantially the same potential”.

In the ion detector according to the above [1], in a case where the positive ions are detected, the first potential that is the negative potential is applied to the conversion dynode, and the second potential higher than the first potential is applied to the first-stage dynode of the electron multiplier. At this time, the third potential which is the negative potential is applied to the box electrode housing the conversion dynode, and the fourth potential which is substantially the same potential as the third potential is applied to the shielding portion disposed in the first opening of the box electrode. Accordingly, the positive ions can be incident on the conversion region of the conversion dynode via the gap of the shielding portion disposed in the first opening of the box electrode. In addition, the electrons emitted from the conversion region can be incident on the first-stage dynode via the second opening of the box electrode. At this time, since the interference between the electric field that causes the positive ions to be incident on the conversion region and the electric field that causes the electrons to be incident on the first-stage dynode is suppressed by the box electrode, the positive ions can be reliably incident on the conversion region, and the electrons can be reliably incident on the first-stage dynode. Further, since the forming of the electric field that attracts the electrons in the box electrode via the first opening is suppressed by the shielding portion, the electrons can be reliably incident on the first-stage dynode. Thus, in accordance with the ion detector according to the above [1], the detection efficiency of the positive ions can be improved.

In the ion detector according to the above [1], in a case where the negative ions are detected, the first potential which is the positive potential is applied to the conversion dynode, and the second potential higher than the first potential is applied to the first-stage dynode of the electron multiplier. At this time, the third potential which is the positive potential is applied to the box electrode housing the conversion dynode, and the fourth potential which is substantially the same potential as the third potential is applied to the shielding portion disposed in the first opening of the box electrode. Accordingly, the negative ions can be incident on the conversion region of the conversion dynode via the gap of the shielding portion disposed in the first opening of the box electrode. In addition, the electrons emitted from the conversion region can be incident on the first-stage dynode via the second opening of the box electrode. At this time, since the interference between the electric field that causes the negative ions to be incident on the conversion region and the electric field that causes the electrons to be incident on the first-stage dynode is suppressed by the box electrode, the negative ions can be reliably incident on the conversion region, and the electrons can be reliably incident on the first-stage dynode. Further, since the shielding portion suppresses the forming of the electric field that pushes back the electrons in the box electrode via the first opening, the electrons can be reliably incident on the first-stage dynode. Thus, in accordance with the ion detector according to the above [1], the detection efficiency of the negative ions can be improved.

As described above, in accordance with the ion detector according to the above [1], it is possible to improve the ion detection efficiency for each of the positive ions and the negative ions.

The ion detector according to an aspect of the present disclosure may be [2] “the ion detector according to the above [1], in which the shielding portion includes, as the gap, a plurality of gaps two-dimensionally disposed along the first opening”. In accordance with the ion detector described in the above [2], in a case where the positive ions are detected, it is possible to cause the positive ions to reliably pass through the first opening while reliably suppressing the forming of the electric field that attracts the electrons emitted from the conversion region in the box electrode via the first opening. In a case where the negative ions are detected, it is possible to cause the negative ions to reliably pass through the first opening while reliably suppressing the forming of the electric field that pushes back the electrons emitted from the conversion region in the box electrode via the first opening. Accordingly, it is possible to further improve the ion detection efficiency for each of the positive ions and the negative ions.

The ion detector according to an aspect of the present disclosure may be [3] “the ion detector according to the above [1] or [2], in which the first opening is disposed on one side with respect to a first center line passing through a center of the conversion region as viewed from a direction perpendicular to the first center line, the second opening is disposed on the other side with respect to the first center line as viewed form the direction perpendicular to the first center line, and the first-stage dynode faces the second opening”. In accordance with the ion detector according to the above [3], since the first-stage dynode faces the second opening of the box electrode, the electric field that causes the electrons to be incident on the first-stage dynode can be easily and reliably formed, and the electrons can be more reliably incident on the first-stage dynode. In addition, since the first opening of the box electrode is disposed on one side with respect to the first center line of the conversion region and the second opening of the box electrode is disposed on the other side with respect to the first center line of the conversion region, it is possible to suppress the influence of the electric field that causes the electrons to be incident on the first-stage dynode on the ions to be detected traveling to the conversion region, and it is possible to more reliably cause the ions to be detected to be incident on the conversion region.

The ion detector according to an aspect of the present disclosure may be [4] “the ion detector according to any one of the above [1] to [3], in which the first potential and the third potential are substantially the same potential”. In accordance with the ion detector according to the above [4], it is possible to facilitate switching of the polarities of the first potential and the third potential corresponding to the polarity of the ion to be detected while simplifying the structure of the potential application unit.

The ion detector according to an aspect of the present disclosure may be [5] “the ion detector according to any one of the above [1] to [4], in which an area of the gap is 50% or more of an area of the first opening”. In accordance with the ion detector according to the above [5], the ions to be detected can be more reliably incident on the conversion region of the conversion dynode via the gap of the shielding portion disposed in the first opening of the box electrode. Accordingly, it is possible to further improve the ion detection efficiency for each of the positive ions and the negative ions.

The ion detector according to an aspect of the present disclosure may be [6] “the ion detector according to any one of the above [1] to [5] further including a partition including an aperture through which the ions traveling to the first opening pass”. In accordance with the ion detector according to the above [6], it is possible to suppress the incidence of the electrons or ions that may be noise into the conversion region. Accordingly, ion detection accuracy can be improved for each of the positive ions and the negative ions.

The ion detector according to an aspect of the present disclosure may be [7] “the ion detector according to the above [6] further including a deflection electrode, in which the box electrode is disposed on one side with respect to a second center line of the aperture as viewed from a direction perpendicular to the second center line, the deflection electrode is disposed on the other side with respect to the second center line as viewed from the direction perpendicular to the second center line, and the potential application unit applies a ground potential or a potential having the same polarity as the polarity of the ions to the deflection electrode”. In accordance with the ion detector according to the above [7], since the electric field that causes the ions to be detected to travel to the first opening of the box electrode can be reliably formed, the ions to be detected can be more reliably incident on the conversion region. Accordingly, it is possible to further improve the ion detection efficiency for each of the positive ions and the negative ions.

The ion detector according to an aspect of the present disclosure may be [8] “the ion detector according to the above [6] or [7], in which the first opening is inclined to be separated from the aperture as the first opening becomes close to a second center line of the aperture as viewed from the direction perpendicular to the second center line”. In accordance with the ion detector according to [8], since the ions to be detected that have passed through the aperture can be reliably made incident on the first opening of the box electrode, the ions to be detected can be more reliably made incident on the conversion region. Accordingly, it is possible to further improve the ion detection efficiency for each of the positive ions and the negative ions.

A mass spectrometer according to an aspect of the present disclosure is [9] “a mass spectrometer including an ionization unit, a mass separation unit, and an ion detector, in which the ion detector includes a conversion dynode including a conversion region where electrons are emitted by incident ions, an electron multiplier including a first-stage dynode on which the electrons are incident, a box electrode housing the conversion dynode, and including a first opening through which the ions traveling to the conversion region pass and a second opening through which the electrons traveling to the first-stage dynode from the conversion region pass, a conductive shielding portion disposed in the first opening and including a gap through which the ions traveling to the conversion region pass, and a potential application unit which applies a first potential to the conversion dynode, applies a second potential to the first-stage dynode, applies a third potential to the box electrode, and applies a fourth potential to the shielding portion, the first potential and the third potential have polarities opposite to a polarity of the ions, the second potential is higher than the first potential, and the third potential and the fourth potential are substantially the same potential”.

In the mass spectrometer according to the above [9], the appropriate potential is applied to the conversion dynode, the first-stage dynode of the electron multiplier, the box electrode, and the shielding portion, and thus, the trajectory of the electrons emitted from the conversion dynode is optimized. Accordingly, even in a case where the spread of the energy distribution and the spatial distribution of the ions transmitted through the mass separation unit is large, it is possible to improve the ion detection efficiency for each of the positive ions and the negative ions.

The mass spectrometer according to an aspect of the present disclosure may be [10] “the mass spectrometer according to the above [9], in which the mass separation unit is a quadrupole mass separation unit”. In accordance with the mass spectrometer according to the above [10], the mass separation unit can be specifically configured.

In accordance with the present disclosure, it is possible to provide the ion detector and the mass spectrometer capable of improving the ion detection efficiency for each of the positive ions and the negative ions.

What is claimed is:

1. An ion detector comprising:
a conversion dynode having a conversion region where electrons are emitted by incident ions;
an electron multiplier including a first-stage dynode on which the electrons are incident;
a box electrode housing the conversion dynode, and including a first opening through which the ions traveling to the conversion region pass and a second opening through which the electrons traveling to the first-stage dynode from the conversion region pass;
a conductive shielding portion disposed in the first opening and including a gap through which the ions traveling to the conversion region pass; and
a potential application unit which applies a first potential to the conversion dynode, applies a second potential to the first-stage dynode, applies a third potential to the box electrode, and applies a fourth potential to the shielding portion, wherein
the first potential and the third potential have polarities opposite to a polarity of the ions,
the second potential is higher than the first potential, and
the third potential and the fourth potential are substantially the same potential.

2. The ion detector according to claim 1, wherein the shielding portion includes, as the gap, a plurality of gaps two-dimensionally disposed along the first opening.

3. The ion detector according to claim 1, wherein
the first opening is disposed on one side with respect to a first center line passing through a center of the conversion region as viewed from a direction perpendicular to the first center line,
the second opening is disposed on the other side with respect to the first center line as viewed form the direction perpendicular to the first center line, and
the first-stage dynode faces the second opening.

4. The ion detector according to claim 1, wherein the first potential and the third potential are substantially the same potential.

5. The ion detector according to claim 1, wherein an area of the gap is 50% or more of an area of the first opening.

6. The ion detector according to claim 1, further comprising a partition including an aperture through which the ions traveling to the first opening pass.

7. The ion detector according to claim 6, further comprising:
a deflection electrode, wherein
the box electrode is disposed on one side with respect to a second center line of the aperture as viewed from a direction perpendicular to the second center line,
the deflection electrode is disposed on the other side with respect to the second center line as viewed from the direction perpendicular to the second center line, and
the potential application unit applies a ground potential or a potential having the same polarity as the polarity of the ions to the deflection electrode.

8. The ion detector according to claim 6, wherein the first opening is inclined to be separated from the aperture as the first opening becomes close to a second center line of the aperture as viewed from the direction perpendicular to the second center line.

9. A mass spectrometer comprising:
an ionization unit;
a mass separation unit; and
an ion detector, wherein
the ion detector includes
a conversion dynode including a conversion region where electrons are emitted by incident ions,
an electron multiplier including a first-stage dynode on which the electrons are incident,
a box electrode housing the conversion dynode, and including a first opening through which the ions traveling to the conversion region pass and a second opening through which the electrons traveling to the first-stage dynode from the conversion region pass,
a conductive shielding portion disposed in the first opening and including a gap through which the ions traveling to the conversion region pass, and
a potential application unit which applies a first potential to the conversion dynode, applies a second potential to the first-stage dynode, applies a third potential to the box electrode, and applies a fourth potential to the shielding portion,
the first potential and the third potential have polarities opposite to a polarity of the ions,
the second potential is higher than the first potential, and
the third potential and the fourth potential are substantially the same potential.

10. The mass spectrometer according to claim 9, wherein
the mass separation unit is a quadrupole mass separation unit.
